(19) United States
(12) Patent Application Publication
(10) Pub. No.: US 2003/0233266 A1
(43) Pub. Date: Dec. 18, 2003

(54) System and method for executing mobile commerce

(76) Inventors: Fu-Yu Liu, Taipei (TW); Yi-Nan Li, Taipei (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/329,070

(22) Filed: Dec. 23, 2002

(30) Foreign Application Priority Data
Jun. 13, 2002 (TW) 91112866

(51) Int. Cl. G06F 17/60

(52) U.S. Cl. 705/8

(57) ABSTRACT

A system for executing mobile commerce includes a database server (101), a mobile commerce server (103), and at least one mobile terminal (109). The mobile terminal downloads business schedules created by the mobile commerce server, to assist execution of commercial activities. The mobile terminal includes a business schedule storing module (301) which stores the downloaded business schedule, and an executing data storing module (303) which records data on execution of commercial activities in accordance with the business schedule. The mobile commerce server includes an application processing module (106) which creates business schedules in accordance with data stored in the database server, and which updates data stored in the database server in accordance with data sent from the mobile terminal. A related method for executing mobile commerce is also disclosed.

### BACKGROUND OF THE INVENTION

1. Field of the Invention

The present invention relates to a system and method for executing mobile commerce, and especially to a system and method for executing mobile commerce by using a mobile terminal. This invention relates to two other applications having the same inventor and the same assignee with the invention, of which one has a title of “SYSTEM AND METHOD FOR REVIEWING DATA IN A MOBILE TERMINAL” and the other has a title of “SYSTEM AND METHOD FOR ASSISTING EXECUTING OF MIBLE COMMERCE”.

2. Background of the Invention

Traditional communication means such as letters, telephones, and faxes are used in a typical conventional business model. In such model, many people waste time on data collection and information transfer. Human error leads to serious mistakes being made, which can cause huge damage to an enterprise. There are also other difficulties including providing adequate technical support, high costs, and low customer satisfaction when mistakes occur.

The development of the Internet has given rise to the electronic business model, which relies on Electronic Data Interchange (EDI). Electronic and digitized information is transferred faster and more accurately. The electronic business model breaks through conventional limitations of time and space, enhances the efficiency of running an enterprise, reduces costs, provides more information, and gives the enterprise more business opportunities. The electronic business model allows clients to easily acquire information on merchandise and on an enterprise, and to contact the enterprise instantaneously via the Internet. Further, data collection and integration is much easier.

US Patent publication No. 20010042020 discloses a method for increasing electronic business. An enterprise uses a computer to show its clients data on merchandise. The clients use computers to send purchase requests to the enterprise via the Internet. Finally, the enterprise and the clients reach settled sales agreements. However, in this method, there is no direct communication between the enterprise and each client. The clients cannot easily obtain more information about the enterprise and its merchandise, and the enterprise cannot easily obtain more information about clients and their requests.

Accordingly, a new business model is desired to make communication between enterprises and clients faster and more accurate, to strengthen technical support, and to yield more client satisfaction.

### SUMMARY OF THE INVENTION

Accordingly, an objective of the present invention is to provide a system for executing mobile commerce by using a mobile terminal.

Another objective of the present invention is to provide a method for conveniently executing mobile commerce.

In order to achieve the first above-mentioned objective, a system for executing mobile commerce in accordance with a preferred embodiment of the present invention comprises a database server, a mobile commerce server, and at least one mobile terminal. The mobile terminal downloads business schedules created by the mobile commerce server, to assist execution of commercial activities. The mobile terminal comprises a business schedule storing module which stores the downloaded business schedule, and an executing data storing module which records data on execution of commercial activities in accordance with the business schedule. The mobile commerce server comprises an application processing module which creates business schedules in accordance with data stored in the database server, and which updates data stored in the database server in accordance with data sent from the mobile terminal.

In order to achieve the second above-mentioned objective, a method for executing mobile commerce in accordance with the present invention comprising the steps of: (a) creating business schedules in accordance with data stored in a database server; (b) transferring data including a business schedule to a mobile terminal; (c) assisting execution of commercial activities in accordance with the transferred business schedule; and (d) recording commercial activities executed in accordance with the transferred business schedule.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a system for executing mobile commerce in accordance with a preferred embodiment of the present invention, the system comprising a database server, a mobile commerce server and at least one mobile terminal;

FIG. 2 is a schematic diagram of detailed infrastructure of the database server of the system of FIG. 1, and shows data communication between the database server, the mobile commerce server and one mobile terminal;

FIG. 3 is a schematic block diagram of function modules of one mobile terminal of the system of FIG. 1;

FIG. 4 is a flowchart of executing mobile commerce in accordance with a preferred embodiment of the present invention; and

FIG. 5 is a flowchart of details of one step of FIG. 4, namely assisting execution of commercial activities.

### DETAILED DESCRIPTION OF PREFERRED EMBODIMENTS OF THE INVENTION

Reference will now be made to the drawings to describe the present invention in detail.

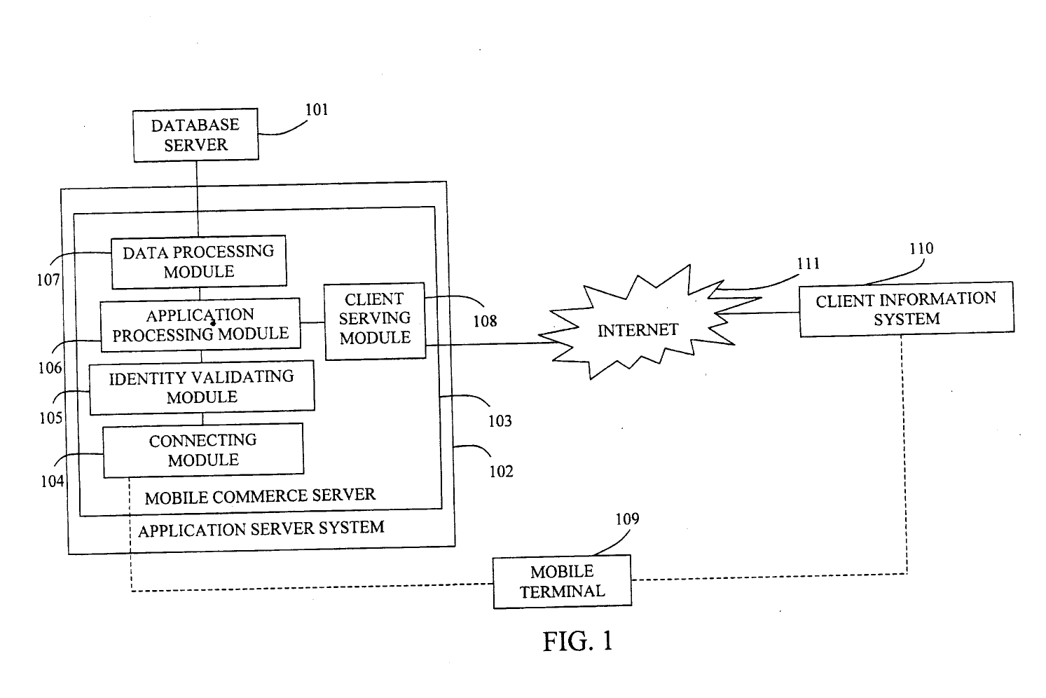

FIG. 1 is a schematic diagram of a system for executing mobile commerce in accordance with a preferred embodiment of the present invention. A three-tier information system comprises a database server 101 (the bottom tier), an application server system 102 (the middle tier), and a plurality of distributed terminal workstations 109 (the top tier, only one shown). The application server system 102 of the present invention comprises a mobile commerce server 103. Each terminal workstation 109 of the present invention is a mobile terminal 109, which can be a Personal Digital Assistant (PDA), a pocket personal computer (PC), a laptop computer, a palmtop computer, a smart phone or a notebook computer. A client information system 110 is connected with each mobile terminal 109 via a cable, infrared signals, or wireless communications. Each mobile terminal 109 connects with the mobile commerce server 103 via a cable, infrared signals, or wireless communications. The mobile commerce server 103 connects with the database server 101, and is used for creating business schedules in accordance with data stored in the database server 101. The mobile terminal 109 downloads a business schedule from the mobile commerce server 103, for assisting execution of commercial activities. The mobile terminal 109 shows steps of required commercial activities in accordance with the business schedule, records data on execution of commercial activities, and uploads data on transactions and on execution of commercial activities for updating of data stored in the client information system 110.

The mobile commerce server 103 comprises a connecting module 104, an identity validating module 105, an application processing module 106, a data processing module 107, and a client serving module 108. The connecting module 104 connects with the mobile terminal 109, and is used for transferring data between the mobile terminal 109 and the mobile commerce server 103. The identity validating module 105 checks identities of personnel such as sales representatives, and distributes various business schedules to various sales representatives. The application processing module 106 creates business schedules for every sales representative in accordance with data stored in the database server 101, and updates data stored in the database server 101 in accordance with data sent from the mobile terminal 109. The data processing module 107 connects with the database server 101, and transfers data between the database server 101 and the mobile commerce server 103. The client serving module 108 connects with the client information system 110 via the Internet 111. The client serving module 108 sends information on mobile commerce to clients, and receives data on cooperating with clients and data on requirements of clients.

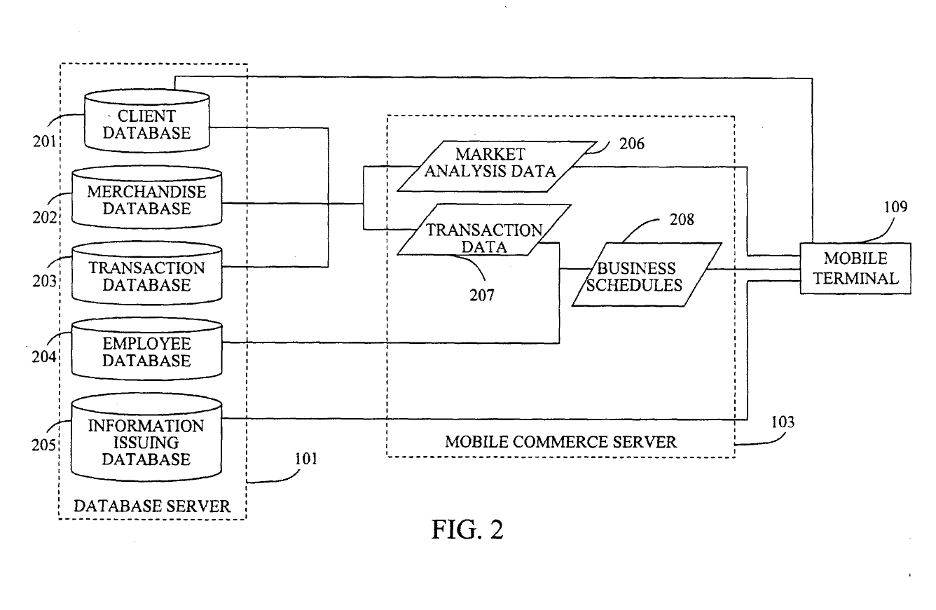

FIG. 2 is a schematic diagram of detailed infrastructure of the database server 101, and shows data communication between the database server 101, the mobile commerce server 103 and one mobile terminal 109. The database server 101 is a central database of an entire enterprise. The database server 101 comprises: a client database 201 for storing data on clients; a merchandise database 202 for storing data on merchandise sold by the enterprise; a transaction database 203 for storing transaction data on the enterprise; an employee database 204 for storing employee data including data on all sales representatives; and an information issuing database 205 for storing information issued by the enterprise. The application processing module 106 of the mobile commerce server 103 integrates data stored in the client database 201, data stored in the merchandise database 202, and data stored in the transaction database 203 to create transaction data 207 and market analysis data 206. The transaction data 207 and the market analysis data 206 are stored in the mobile commerce server 103. The transaction data 207 and data stored in the employee database 204 are processed by the application processing module 106 to create business schedules 208 for sales representatives. The business schedules 208 are stored in the mobile commerce server 103. During the process of downloading data from the mobile commerce server 103, the business schedules 208, the market analysis data 206, data stored in the client database 201, and data stored in the information issuing database 205 are transferred to the mobile terminal 109 via the connecting module 104 of the mobile commerce server 103.

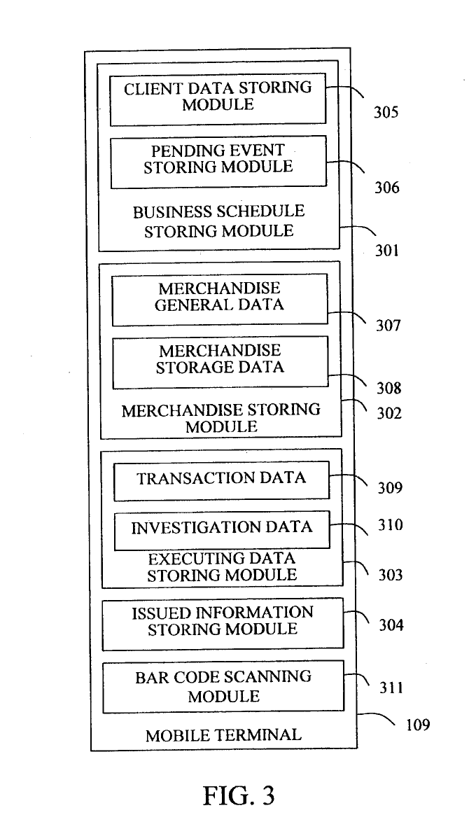

FIG. 3 is a schematic block diagram of function modules of one mobile terminal 109. The mobile terminal 109 comprises: a business schedule storing module 301 which is used to record work flow and clients that a sales representative visits; a merchandise storing module 302 which is used to store all merchandise information on the enterprise as a reference for the sales representative to inquire of; an executing data storing module 303 which is used to record data on execution of commercial activities; an issued information storing module 304 which is used to store information on the enterprise's current news, merchandise shortage notes, and newly promoted products; and a bar code scanning module 311 which is used to scan and identify various clients' bar codes which respectively represent various clients.

The business schedule storing module 301 comprises a client data storing module 305, and a pending event storing module 306. The client data storing module 305 stores commercial activities information on clients, including client basic data such as name, address and phone number, client ordering data, and accounts receivable. The pending event storing module 306 is used to remind the sales representative of matters that need to be attended to. For instance, such matters may be orders that need conducting, collection of accounts receivable, and market investigation. The merchandise storing module 302 comprises merchandise general data 307 and merchandise storage data 308. The merchandise general data 307 includes basic merchandise data such as name, serial number and specification, merchandise price data and key merchandise data. The merchandise storage data 308 includes corresponding merchandise inventory volume and distribution information. The executing data storing module 303 stores transaction data 309 and investigation data 310. The information in the executing data storing module 303 is sent to the mobile commerce server 103, and is processed by the application processing module 106. The information in the database server 101 is updated accordingly.

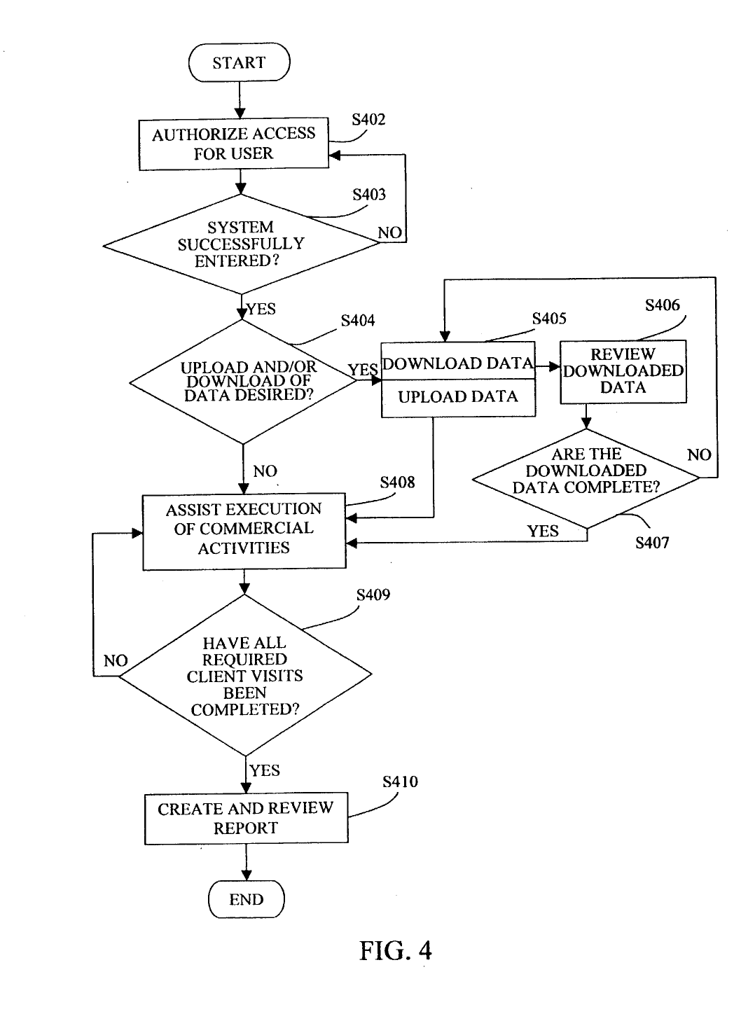

FIG. 4 is a flowchart of executing mobile commerce in accordance with a preferred embodiment of the present invention. Firstly, in step S402, before a user enters the system, the mobile terminal 109 authorizes access for the user. In step S403, if the user cannot successfully enter the system, then the procedure returns to step S402. If the user successfully enters the system, then in step S404, the mobile terminal 109 inquires whether or not the user wants to upload and/or download data. If the user does not want to upload or download data, then the procedure proceeds directly to step S408. Otherwise, in step S405, the mobile terminal 109 downloads data including a business schedule from the mobile commerce server 103, and/or uploads data on execution of commercial activities already completed to the executing data storing module 303 of the mobile commerce server 103. These download and upload operations can be performed individually and separately. If the mobile terminal 109 only uploads data, then the procedure proceeds directly to step S408. If the mobile terminal 109 downloads data, then in step S406, when all the data has been downloaded, the mobile terminal 109 displays both data wanted by the user for executing commercial activities and the downloaded data. The user compares the wanted data with the downloaded data, and marks any outstanding wanted data. Then, in step S407, the business schedule storing module 301 determines whether the downloaded data are complete having regard to the user's mark, if any. If the downloaded data are not complete, then the procedure returns to step S405, and the outstanding wanted data are downloaded. If the downloaded data are complete, then the procedure proceeds to step S408. In step S408, the actual commercial activities are performed, and the executing data storing module 303 records corresponding operations during the process of execution of the commercial activities. When the commercial activities are finished, in step S409 the business schedule storing module 301 determines whether all required visits to clients have been completed. If all required client visits have not been completed, then the procedure returns to step S408 and the sales representative continues to visit other clients. If and when all required client visits have been completed, then in step S410, the executing data storing module 303 collects and analyzes all client visit information on the business schedule, and generates a consolidated report for the sales representative to review.

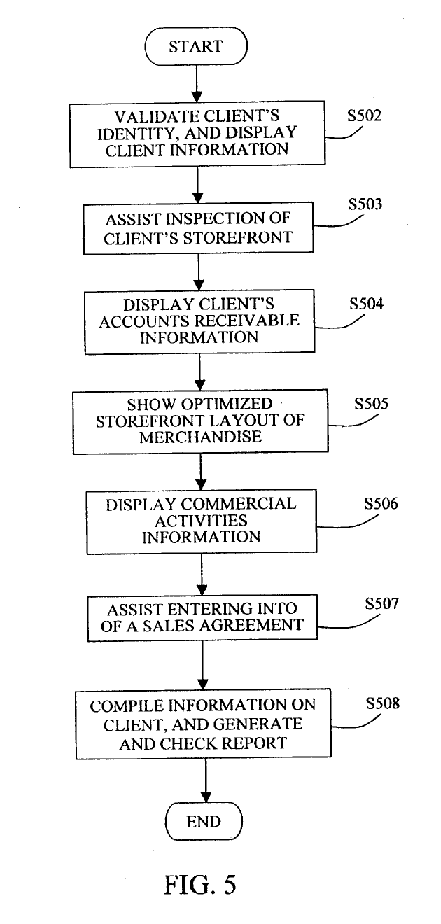

FIG. 5 is a flowchart of details of step S408 of FIG. 4, namely assisting execution of commercial activities. Firstly, in step S502 the mobile terminal 109 validates a client's identity, and displays corresponding client information. The client's identity can be validated by either scanning the client's bar code, or manually entering the client's name, code or other details. The client information includes basic information on the client.

In step S503, the mobile terminal 109 assists the user in inspecting the client's storefront premises. Matters examined may include verification of the enterprise's merchandise inventory, checking of the client's merchandise information, investigation of merchandise prices, investigation of fake products, and compiling of questionnaires. The executing data storing module 303 records the client visit and noteworthy matters arising from the visit. All this information is transferred to the mobile commerce server 103, so that the next business schedule can be arranged. In step S504, the business schedule storing module 301 displays the client's accounts receivable information, and reminds the sales representative to collect any outstanding payments. The application processing module 106 of the mobile server 103 computes a new optimized storefront layout of merchandise, based on the enterprise's sales strategy, the client's current storefront layout, the client's previous storefront layouts, and previous storefront layouts by other clients. In step S505, the new optimized storefront layout is stored in the business schedule storing module 301, and is shown on the mobile terminal 109. The new optimized storefront layout is used to guide the client to adjust its storefront layout of merchandise at its storefront premises. In step S506, the business schedule storing module 301 shows the enterprise's scheduled commercial activities on the mobile terminal 109. Such scheduled activities are used to assist the client to make its own sales strategy.

In step S507, the mobile terminal 109 assists the sales representative to enter into a sales agreement with the client. Firstly, the executing data storing module 303 automatically creates a sales order in accordance with verified merchandise inventory information and a merchandise sales record of the client. The sales representative modifies the order in light of consultations with the client. When a final order is created, the mobile terminal 109 displays a notice advising whether the total price of the order is within the client's credit allowance. If the client wants to return merchandise, the executing data storing module 303 records data on returned merchandise.

Finally, in step S508 the executing data storing module 303 compiles information on the client, and generates a report on the client for the sales representative to check. All such information and the report are sent to the mobile commerce server 103, and processed by the application processing module 106. Subsequently, the processed information is transferred to the database server 101, and the application processing module 106 updates all data stored in corresponding databases.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for executing mobile commerce, the system comprising:
a database server;
a mobile commerce server electronically linked with the database server; and
at least one mobile terminal electronically linked with the mobile commerce server for downloading a business schedule from the mobile commerce server to assist execution of commercial activities,
the at least one mobile terminal comprising a business schedule storing module for storing the downloaded business schedule, and an executing data storing module for recording information on execution of commercial activities;
wherein the mobile commerce server comprises an application processing module for creating a plurality of business schedules in accordance with data stored in the database server, and for updating data stored in the database server in accordance with data sent from the at least one mobile terminal.

2. The system for executing mobile commerce as claimed in claim 1, wherein the mobile commerce server further comprises an identity validating module for distinguishing identities of sales representatives, and for distributing different business schedules to different sales representatives.

3. The system for executing mobile commerce as claimed in claim 1, wherein the at least one mobile terminal further comprises a bar code scanning module for recognizing bar codes of clients.

4. A method for executing mobile commerce, the method comprising the steps of:
(a) creating a plurality of business schedules in accordance with data stored in a database server;
(b) transferring data including a business schedule to a mobile terminal;
(c) assisting execution of commercial activities in accordance with the transferred business schedule; and
(d) recording commercial activities executed in accordance with the transferred business schedule.

5. The method for executing mobile commerce as claimed in claim 4, further comprising the step of:
uploading data on executed commercial activities to a mobile commerce server.

6. The method for executing mobile commerce as claimed in claim 4, wherein step (c) of assisting execution of commercial activities in accordance with the transferred business schedule comprises the steps of:
(c1) validating a client's identity, and displaying data on the client;
(c2) displaying steps of required commercial activities;
(c3) recording data created during execution of commercial activities;
(c4) generating a report on the client using data recorded during execution of commercial activities; and
(c5) repeating steps (c1) through (c4) until the transferred business schedule has been fully executed.

7. A method for executing mobile commerce, the method comprising the steps of:
(a) creating a plurality of business schedules in accordance with data stored in a database server;
(b) transferring data including a business schedule to a mobile terminal;
(c) validating a client's identity, and displaying data on the client;
(d) displaying steps of required commercial activities;
(e) recording commercial activities following said steps in accordance with the business schedule.

8. The method for executing mobile commerce as claimed in claim 7, further comprising the step of:
(f) uploading data on executed commercial activities to a mobile commerce server.

9. The method for executing mobile commerce as claimed in claim 7, wherein said recording commercial activities including steps of:
(g) recording data created during execution of commercial activities;
(h) generating a report on the client using said data recorded during execution of commercial activities;
(i) repeating steps (c), (d), (g) and (h) until the business schedule has been fully executed.
